(19) United States
(12) Patent Application Publication
(10) Pub. No.: US 2025/0134103 A1
(43) Pub. Date: May 1, 2025

(54) PESTICIDAL MIXTURES COMPRISING AN ISOCHINOLINE COMPOUND

(71) Applicant: BASF SE, Ludwigshafen (DE)

(72) Inventors: Robert Reinhard, Limburgerhof (DE); Karsten Koerber, Ludwigshafen (DE); Juergen Langewald, Mannheim (DE)

(21) Appl. No.: 18/692,876

(22) PCT Filed: Sep. 12, 2022
(86) PCT No.: PCT/EP2022/075211

§ 371 Date: Mar. 18, 2024

(30) Foreign Application Priority Data
Sep. 22, 2021 (EP) 21198335.8

(51) Int. Cl. A01N 43/80; A01P 17/00

(52) U.S. Cl. CPC A01N 43/80; A01P 17/00

(57) ABSTRACT

Pesticidal mixtures comprising as active compounds 1) at least one isochinoline compound A of formula I: wherein R is CH₂-pyrimidine-2 or cyclpropyl; and 2) at least one further compound B selected from ethiprole and fipronil; alpha-cypermethrin, bifenthrin, cyfluthrin, etofenprox, lamda-cyhalothrin, gamma-cyhalothrin, deltamethrin; thiameth-oxam, imidacloprid, clothianidin, acetamiprid, thiacloprid, dinotefuran, nitenpyram, sulfoxaflor, flupyradifurone, triflumezopyrim; spinosad, spinetoram; abamectin, emamectin benzoate; pyriproxyfen; pymetrozine, afidopyropen; chlorfenapyr; teflubenzuron; buprofezin; methoxyfeno-zide; indoxacarb; spirotetramat, spiropidion, spidoxamat; chlorantraniliprole, cyantraniliprole, cyhalodiamide, cyclaniliprole, flubendiamide, tetrachlorantraniliprole, tetraniliprole; flonicamid; broflanilide; dicloromezotiaz, dimpropyridaz, flupyrimin, and oxazosulfyl; methods and use of these mixtures for combating invertebrate pests such as insects, arachnids or nematodes in and on plants, and for protecting such plants being infested with pests, especially also for protecting plant propagation material as like seeds.

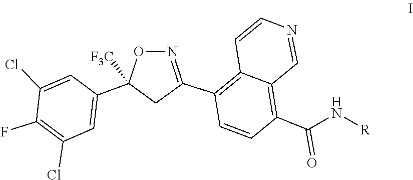

The invention relates to a pesticidal mixture comprising as active compounds at least one isochinoline compound and at least one further pesticide. Furthermore, the invention relates to methods of applying said mixture.

The invention thus relates to pesticidal mixtures comprising as active compounds
A) at least one isochinoline compound A selected from the compounds of formula I:

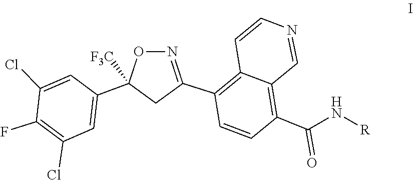

wherein
R is CH₂-pyrimidine-2, or cyclpropyl;
and
B) at least one further compound B selected from
   1) M.2 GABA-gated chloride channel antagonists: ethiprole and fipronil;
   2) M.3 pyrethroids: alpha-cypermethrin, bifenthrin, cyfluthrin, etofenprox, lamda-cyhalothrin, gamma-cyhalothrin, and deltamethrin;
   3) nAChR agonists: thiamethoxam, imidacloprid, clothianidin, acetamiprid, thiacloprid, dinotefuran, nitenpyram, sulfoxaflor, flupyradifurone, and triflumezopyrim;
   4) spinosyns: spinosad and spinetoram;
   5) M.6 avermectins: abamectin, and emamectin benzoate;
   6) M.7 juvenile hormone analogue pyriproxyfen;
   7) M.9 pymetrozine and afidopyropen;
   8) M.13 Uncoupler of oxidative phosphorylation via disruption of the proton gradient: chlorfenapyr;
   9) M.15 Inhibitor of the chitin biosynthesis type 0: teflubenzuron;
   10) M.16 Inhibitor of the chitin biosynthesis type 1: buprofezin;
   11) M.18 Ecdyson receptor agonist: methoxyfenozide;
   12) M.22 Voltage-dependent sodium channel blocker: indoxacarb;
   13) M.23 Inhibitors of the of acetyl CoA carboxylase: spirotetramat, spiropidion, and spidoxamat;
   14) M.28 Ryanodine receptor-modulators: chlorantraniliprole, cyantraniliprole, cyhalodiamide, cyclaniliprole, flubendiamide, tetrachlorantraniliprole, and tetraniliprole;
   15) M.29: Chordotonal organ Modulator: flonicamid;
   16) M.30: broflanilide;
   17) M.UN. Unknown mode of action: dicloromezotiaz, dimpropyridaz, flupyrimin, and oxazosulfyl;
wherein component A and component B are present in a weight ratio of from 1000:1 to 1:1000.

One typical problem arising in the field of pest control lies in the need to reduce the dosage rates of the active ingredient in order to reduce or avoid unfavorable environmental or toxicological effects whilst still allowing effective pest control. Another problem encountered concerns the need to have available pest control agents which are effective against a broad spectrum of pests.

Another difficulty in relation to the use of pesticides is that the repeated and exclusive application of an individual pesticidal compound leads in many cases to a rapid selection of pests which have developed natural or adapted resistance against the active compound in question.

Therefore, there is a need for pest control agents that help prevent or overcome resistance.

WO 2020/055955 describes isooxazoline compounds of formula I. These compounds are mentioned to be useful for combating invertebrate pests.

It is therefore an object of the invention to provide pesticidal mixtures and/or compounds which solves at least one of the discussed problems as reducing the dosage rate, enhancing the spectrum of activity or combining knock-down activity with prolonged control or as to resistance management.

It has been found that at least one of these objectives is achieved by the combination of active compounds defined in the outset.

Moreover, it has also been found that simultaneous, that is joint or separate, application of one or more active compounds A and one or more active compounds B or successive application of one or more active compounds A and one or more active compounds B allows enhanced control of pests compared to the control rates that are possible with the individual compounds.

Moreover, the invention relates to
a composition comprising the pesticidal mixture as defined herein and at least one inert liquid and/or solid acceptable carrier;
an agricultural composition comprising the pesticidal mixture as defined herein and at least one inert liquid and/or solid acceptable carrier;
a method for controlling or combating invertebrate pests, comprising contacting said pest or its food supply, habitat, breeding grounds with a pesticidally effective amount of the pesticidal mixture as defined herein;
a method of protecting plants from attack or infestation by invertebrate pests, contacting a plant, a plant propagation material or soil or water in which the plant is growing, with a pesticidally effective amount of the pesticidal mixture as defined herein;
a plant propagation material comprising the pesticidal mixture as defined herein in an amount of from 0.1 g to 10 kg per 100 kg of seed;
a method for protection of plant propagation material comprising contacting the plant propagation material with the pesticidal mixture as defined herein in an amount of from 0.1 g to 10 kg per 100 kg of plant propagation material;
the use of the pesticidal mixture as defined herein for protecting growing plants or plant propagation material from attack or infestation by invertebrate pests;
a method for controlling phytopathogenic harmful fungi, wherein the fungi, their habitat or the plants to be protected against fungal attack, the soil or seed are treated with an effective amount of the pesticidal mixture comprising at least one compound A as defined herein and at least one specific compound B as defined herein;
a method for protecting plants from phytopathogenic harmful fungi, wherein the fungi, their habitat or the plants to be protected against fungal attack, the soil or seed are treated with an effective amount of the pesticidal mixture comprising at least one compound A as defined herein and at least one specific compound B as defined herein;
a method for protecting animals against infestation or infection by parasites which comprises administering to the animals a parasitically effective amount of the pesticidal mixture as defined herein;
a method for treating animals infested or infected by parasites which comprises administering to the animals a parasitically effective amount of the pesticidal mixture as defined herein to the animal in need thereof; and
the use of the pesticidal mixture as defined herein for combating parasites in and on animals.

The mixture according to the invention may be a physical mixture of the at least one compound A and the at least one compound B. Accordingly, the invention also provides a mixture comprising at least one compound A and at least one compound B. However, the composition may also be any combination of at least one compound A with at least one compound B, it not being required for compounds A and B to be present together in the same formulation.

An example of a composition according to the invention or to be used according to the invention in which the at least one compound A and the at least one compound B are not present together in the same formulation is a combipack. In a combipack, two or more components of a combipack are packaged separately, i.e., not jointly pre-formulated. As such, combipacks include one or more separate containers such as vials, cans, bottles, pouches, bags or canisters, each container containing a separate component for an agrochemical composition. One example is a two-component combipack. Accordingly, the invention also relates to a two-component combipack, comprising a first component which in turn comprises at least one compound A, a liquid or solid carrier and, if appropriate, at least one surfactant and/or at least one customary auxiliary, and a second component which in turn comprises at least one compound B, a liquid or solid carrier and, if appropriate, at least one surfactant and/or at least one customary auxiliary. More details, e.g. as to suitable liquid and solid carriers, surfactants and customary auxiliaries are described below.

The “combined” use of at least one compound A “in combination with” at least one compound B on the one hand can be understood as using a physical mixture of at least one compound A and at least one compound B. On the other hand, the combined use may also consist in using the at least one compound A and the at least one compound B separately, but within a sufficiently short time of one another so that the desired effect can take place. More detailed illustrations of the combined use can be found in the specifications below.

The term “invertebrate pest” (also referred to as animal pests) as used herein encompasses animal populations, such as insects, arachnids and nematodes, which may attack plants, thereby causing substantial damage to the plants attacked, as well as ectoparasites which may infest animals, in particular warm-blooded animals such as e.g. mammals or birds, or other higher animals such as reptiles, amphibians or fish, thereby causing substantial damage to the animals infested.

The term “compound(s) according to the invention”, or “compound(s) of formula I” or “compound(s) A” comprises the compound(s) as defined herein as well as a stereoisomer, salt, tautomer or N-oxide thereof. The term “compound(s) of the invention” is to be understood as equivalent to the term “compound(s) according to the invention”, therefore also comprising a stereoisomer, salt, tautomer or N-oxide thereof.

The term “stereoisomers” encompasses both optical isomers, such as enantiomers or diastereomers, the latter existing due to more than one center of chirality in the molecule, as well as geometrical isomers (cis/trans isomers).

The compounds of the invention may be amorphous or may exist in one or more different crystalline states (polymorphs) which may have a different macroscopic properties such as stability or show different biological properties such as activities. The invention includes both amorphous and crystalline compounds of the formula I, mixtures of different crystalline states of the respective compound I, as well as amorphous or crystalline salts thereof.

Salts of the compounds of the formula I are preferably agriculturally and veterinarily acceptable salts. They can be formed in a customary method, e.g. by reacting the compound with an acid of the anion in question if the compound of formula I has a basic functionality or by reacting an acidic compound of formula I with a suitable base.

Suitable agriculturally acceptable salts are especially the salts of those cations or the acid addition salts of those acids whose cations and anions, respectively, do not have any adverse effect on the action of the compounds according to the invention. Suitable cations are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH₄⁺) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethylammonium, bis(2-hydroxyethyl)ammonium, benzyltrimethylammonium and benzl-triethylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C₁-C₄-alkanoic acids, preferably formate, acetate, propionate and butyrate. They can be formed by reacting a compound of formulae I with an acid of the corresponding anion, preferably of hydrochloric acid, hydrobromic acid, sulfuric acid, phosphoric acid or nitric acid.

The organic moieties mentioned in the above definitions of the variables are—like the term halogen—collective terms for individual listings of the individual group members. The prefix Cₙ-Cₘ indicates in each case the possible number of carbon atoms in the group.

The commercially available further compounds B may be found in The Pesticide Manual, 18th Edition, British Crop Protection Council (2018) among other publications, and its online data-base https://www.bcpc.org/product/bcpc-online-pesticide-manual-latest-version.

We have found that simultaneous, that is joint or separate, application of at least one compound I and at least one compound B or successive application of at least one of the compounds(s) of formula I and at least one compound B allows better control of animal pests than is possible with the individual compounds alone (synergistic mixtures).

The compounds of formula I can be used as synergists for certain insecticidal active compounds. By simultaneous, that is joint or separate, application of compound(s) of formula I with at least one active compound B, the insecticidal activity is increased in a superadditive manner.

The compounds of the formula I can be present in different crystal modifications, which may differ in biological activity.

An embodiment of the invention relates to pesticidal mixtures wherein component A is selected from compounds I-1 and I-2:
(I-1): 5-[(5S)-5-(3,5-dichloro-4-fluoro-phenyl)-5-(trifluoromethyl)-4H-isoxazol-3-yl]-N-(pyrimidin-2-ylmethyl)isoquinoline-8-carboxamide, and
(I-2): N-cyclopropyl-5-[(5S)-5-(3,5-dichloro-4-fluoro-phenyl)-5-(trifluoromethyl)-4H-isoxazol-3-yl]isoquinoline-8-carboxamide.

A preferred embodiment of the invention relates to pesticidal mixtures wherein component A is compound I-1.

Preferred embodiments of the invention relate to pesticidal mixtures wherein component A and component B are present in a total weight ratio of from 20:1 to 1:500, preferably 10:1 to 1:100, more preferably 10:1 to 1:50, more preferably 10:1 to 1:25, particularly 10:1 to 1:10.

Particular aspects of the invention are any one of pesticidal mixtures A, B, C, D, E, F, G, H, J, K, L, M, N, O, and P:

Pesticidal mixture A comprises as active components
A1) at least one compound of formula I, and
A2) GABA-gated chloride channel antagonists selected from
   1a) ethiprole, and
   1b) fipronil,
wherein component A1) and component A2) are present in a total weight ratio of from 1000:1 to 1:1000, preferably 100:1 to 1:100, more preferably 50:1 to 1:50, more preferably 25:1 to 1:25, particularly 10:1 to 1:10. In the afore mentioned ratios one embodiment relates to ratios from 1:1 to excessive component A1; in another embodiment the ratios are from 1:1 to excessive component A2.

Preferred embodiments are mixtures wherein compound A2 is 1b, particularly in mixture ratios of 1:1 to 1:50.

Pesticidal mixture B comprises as active components
1) at least one compound of formula I, and
B2) a pyrethroide selected from
   2a) alpha-cypermethrin;
   2b) bifenthrin;
   2c) cyfluthrin;
   2d) etofenprox;
   2e) lamda-cyhalothrin;
   2f) gamma-cyhalothrin; and
   2g) deltamethrin,
wherein component B1) and component B2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component B1; in another embodiment the ratios are from 1:1 to excessive component B2.

Preferred mixtures B are the combinations listed in Table B:

| No. | Component B1 | Component B2 |
|---|---|---|
| B-1 | I-1 | 2a |
| B-2 | I-2 | 2a |
| B-3 | I-1 | 2b |
| B-4 | I-2 | 2b |
| B-5 | I-1 | 2c |
| B-6 | I-2 | 2c |
| B-7 | I-1 | 2d |
| B-8 | I-2 | 2d |
| B-9 | I-1 | 2e |
| B-10 | I-2 | 2e |
| B-11 | I-1 | 2f |
| B-12 | I-2 | 2f |
| B-13 | I-1 | 2g |
| B-14 | I-2 | 2g |

Particularly preferred embodiments are mixtures wherein compound B2 is selected from 2a, 2b, 2e, 2f, and 2g, particularly in mixture ratios of from 1:1 to 1.100.

Pesticidal mixture C comprises as active components
C1) at least one compound of formula I, and
C2) a nAChR agonists selected from
   3a) thiamethoxam,
   3b) imidacloprid,
   3c) clothianidin,
   3d) acetamiprid,
   3e) thiacloprid,
   3f) dinotefuran,
   3g) nitenpyram,
   3h) sulfoxaflor,
   3i) flupyradifurone,
   3j) triflumezopyrim,
wherein component C1) and component C2) are present in a total weight ratio of from 1000:1 to 1:1000, preferably 500:1 to 1:500, more preferably 100:1 to 1:100, more preferably 25:1 to 1:25, particularly 10:1 to 1:10. In the afore mentioned ratios one embodiment relates to ratios from 1:1 to excessive component C1; in another embodiment the ratios are from 1:1 to excessive component C2.

Preferred mixtures C are the combinations listed in Table C:

| No. | Component C1 | Component C2 |
|---|---|---|
| C-1 | I-1 | 3a |
| C-2 | I-2 | 3a |
| C-3 | I-1 | 3b |
| C-4 | I-2 | 3b |
| C-5 | I-1 | 3c |
| C-6 | I-2 | 3c |
| C-7 | I-1 | 3d |
| C-8 | I-2 | 3d |
| C-9 | I-1 | 3e |
| C-10 | I-2 | 3e |
| C-11 | I-1 | 3f |
| C-12 | I-2 | 3f |
| C-13 | I-1 | 3g |
| C-14 | I-2 | 3g |
| C-15 | I-1 | 3h |
| C-16 | I-2 | 3h |
| C-17 | I-1 | 3i |
| C-18 | I-2 | 3i |
| C-19 | I-1 | 3j |
| C-20 | I-2 | 3j |

Particularly preferred embodiments are mixtures wherein compound C2 is selected from 3a, 3b, 3c, 3d, 3e, 3f, and 3h, particularly in mixture ratios of from 10:1 to 1:500.

Pesticidal mixture D comprises as active components
D1) at least one compound of formula I, and
D2) a spinosyn selected from
4a) spinosad, and
4b) spinetoram,
wherein component D1) and component D2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component D1; in another embodiment the ratios are from 1:1 to excessive component D2.

Mixtures D are the combinations listed in Table D:

| No. | Component D1 | Component D2 |
|---|---|---|
| D-1 | I-1 | 4a |
| D-2 | I-2 | 4a |
| D-3 | I-1 | 4b |
| D-4 | I-2 | 4b |

Mixtures D are particularly preferred embodiments of the invention, particularly in mixture ratios of from 1:1 to 1:25.

Pesticidal mixture E comprises as active components
E1) at least one compound of formula I, and
E2) M.6 avermectins selected from
   5a) abamectin, and
   5b) emamectin benzoate,
wherein component E1) and component E2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component E1; in another embodiment the ratios are from 1:1 to excessive component E2.

Mixtures E are the combinations listed in Table E:

| No. | Component E1 | Component E2 |
|---|---|---|
| E-1 | I-1 | 5a |
| E-2 | I-2 | 5a |
| E-3 | I-1 | 5b |
| E-4 | I-2 | 5b |

Mixtures E are particularly preferred embodiments of the invention.

Pesticidal mixture F comprises as active components
F1) at least one compound of formula I, and
F2) compounds selected from
   6a) afidopyropen, and
   6b) pyriproxyfen,
wherein component F1) and component F2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component F1; in another embodiment the ratios are from 1:1 to excessive component F2.

Mixtures F are the combinations listed in Table F:

| No. | Component F1 | Component F2 |
|---|---|---|
| F-1 | I-1 | 6a |
| F-2 | I-2 | 6a |
| F-3 | I-1 | 6b |
| F-4 | I-2 | 6b |

Particularly preferred embodiments are mixtures wherein compound F2 is 6a.

Pesticidal mixture G comprises as active components
G1) at least one compound of formula I, and
G2) Chlorfenapyr,
wherein component G1) and component G2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component G1; in another embodiment the ratios are from 1:1 to excessive component G2.

Mixtures G are preferred embodiments of the invention, particularly in mixture ratios of from 1:1 to 1:10.

Pesticidal mixture H comprises as active components
H1) at least one compound of formula I, and
H2) Teflubenzuron,
wherein component H1) and component H2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component H1; in another embodiment the ratios are from 1:1 to excessive component H2.

Mixtures H are preferred embodiments of the invention.

Pesticidal mixture J comprises as active components
J1) at least one compound of formula I, and
J2) Methoxyfenozide,
wherein component J1) and component J2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component J1; in another embodiment the ratios are from 1:1 to excessive component J2.

Mixtures J are preferred embodiments of the invention, particularly in mixture ratios of from 1:1 to 1:25.

Pesticidal mixture K comprises as active components
K1) at least one compound of formula I, and
K2) Indoxacarb,
wherein component K1) and component K2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component K1; in another embodiment the ratios are from 1:1 to excessive component K2.

Mixtures K are preferred embodiments of the invention, particularly in mixture ratios of from 20:1 to 1:10.

Pesticidal mixture L comprises as active components
L1) at least one compound of formula I, and
L2) an inhibitor of the of acetyl CoA carboxylase selected from
   13a) spirotetramat,
   13b) spiropidion, and
   13c) spidoxamat,
wherein component L1) and component L2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component L1; in another embodiment the ratios are from 1:1 to excessive component L2.

Mixtures L are the combinations listed in Table L:

| No. | Component C1 | Component C2 |
|---|---|---|
| L-1 | I-1 | 13a |
| L-2 | I-2 | 13a |
| L-3 | I-1 | 13b |
| L-4 | I-2 | 13b |
| L-5 | I-1 | 13c |
| L-6 | I-2 | 13c |

Mixtures L are particularly preferred embodiments of the invention, particularly in mixture ratios of from 1:1 to 1:400.

Pesticidal mixture M comprises as active components
M1) at least one compound of formula I, and
M2) a Ryanodine receptor-modulator selected from
   14a) Flubendiamide,
   14b) Chlorantraniliprole,
   14c) Cyantraniliprole,
   14d) Tetraniliprole,
   14e) Tetrachlorantraniliprole,
   14f) Cyclaniliprole,
   14g) Cyhalodiamide,
wherein component M1) and component M2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component M1; in another embodiment the ratios are from 1:1 to excessive component M2.

Preferred mixtures M are the combinations listed in Table M:

| No. | Component M1 | Component M2 |
|---|---|---|
| M-1 | I-1 | 14a |
| M-2 | I-2 | 14a |
| M-3 | I-1 | 14b |
| M-4 | I-2 | 14b |
| M-5 | I-1 | 14c |
| M-6 | I-2 | 14c |
| M-7 | I-1 | 14d |
| M-8 | I-2 | 14d |

Particularly preferred embodiments are mixtures wherein compound C2 is selected from 14b, and 14c, particularly in mixture ratios of from 1:1 to 1:50.

Pesticidal mixture N comprises as active components
N1) at least one compound of formula I, and
N2) Flonicamid,
wherein component N1) and component N2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component N1; in another embodiment the ratios are from 1:1 to excessive component N2.

Mixtures N are preferred embodiments of the invention.

Pesticidal mixture O comprises as active components
O1) at least one compound of formula I, and
O2) Broflanilide,
wherein component O1) and component O2) are present in a total weight ratio of from 1000:1 to 1:1000, preferably 100:1 to 1:100, more preferably 25:1 to 1:25, particularly 10:1 to 1:10. In the afore mentioned ratios one embodiment relates to ratios from 1:1 to excessive component O1; in another embodiment the ratios are from 1:1 to excessive component O2.

Mixtures O are preferred embodiments of the invention, particularly in mixture ratios of from 1:1 to 1:250.

Pesticidal mixture P comprises as active components
P1) at least one compound of formula I, and
P2) a compound with unknown mode of action, selected from
   17a) dicloromezotiaz,
   17b) dimpropyridaz,
   17c) flupyrimin, and
   17d) oxazosulfyl,
   wherein component P1) and component P2) are present in a total weight ratio of from 1000:1 to 1:1000, preferably 25:1 to 1:25, particularly 10:1 to 1:10. In the afore mentioned ratios one embodiment relates to ratios from 1:1 to excessive component P1; in another embodiment the ratios are from 1:1 to excessive component P2.

Mixtures P are the combinations listed in Table P:

| No. | Component P1 | Component P2 |
|---|---|---|
| P-1 | I-1 | 17a |
| P-2 | I-2 | 17a |
| P-3 | I-1 | 17b |
| P-4 | I-2 | 17b |
| P-5 | I-1 | 17c |
| P-6 | I-2 | 17c |
| P-7 | I-1 | 17d |
| P-8 | I-2 | 17d |

Particularly preferred embodiments are mixtures wherein compound P2 is selected from 17a, and 17b, particularly in mixture ratios of from 5:1 to 1:2.

Binary mixtures of a compound of formula I and a compound B are one preferred embodiment of the invention.

The invention also relates to agrochemical compositions comprising an auxiliary and a mixture of the invention.

An agrochemical composition comprises a pesticidally effective amount of a mixture of the invention.

The compounds I can be converted into customary types of agro-chemical compositions, e.g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials e.g. seeds (e.g. GF). These and further compositions types are defined in the “Catalogue of pesticide formulation types and international coding system”, Technical Monograph No. 2, 6th Ed. May 2008, CropLife International. The compositions are prepared in a known manner, e.g. described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents. Suitable solid carriers or fillers are mineral earths.

Suitable surfactants are surface-active compounds, e.g. anionic, cationic, nonionic, and amphoteric surfactants, block polymers, polyelectrolytes. Such surfactants can be used as emulsifier, dispersant, solubilizer, wetter, penetration enhancer, protective colloid, or adjuvant. Surfactants are listed in McCutcheon's, Vol. 1: Emulsifiers & Detergents, McCutcheon's Directories, Glen Rock, USA, 2008 (International or North American Ed.). Suitable anionic surfactants are alkali, alkaline earth, or ammonium salts of sulfonates, sulfates, phosphates, carboxylates. Suitable nonionic surfactants are alkoxylates, N-substituted fatty acid amides, amine oxides, esters, sugar-based surfactants, polymeric surfactants. Suitable cationic surfactants are qua-ternary surfactants.

The agrochemical compositions generally comprise between 0.01 and 95%, preferably between 0.1 and 90%, and most preferably between 0.5 and 75%, by weight of active substance. The active substances are employed in a purity of from 90% to 100%, preferably from 95% to 100%.

Various types of oils, wetters, adjuvants, or fertilizer may be added to the active substances or the compositions comprising them as premix or, if appropriate not until immediately prior to use (tank mix). These agents can be admixed with the compositions according to the invention in a weight ratio of 1:100 to 100:1.

The user applies the composition according to the invention usually from a predosage device, a knapsack sprayer, a spray tank, a spray plane, or an irrigation system. Usually, the agro-chemical composition is made up with water, buffer, and/or further auxiliaries to the desired application concentration and the ready-to-use spray liquor or the agrochemical composition according to the invention is thus obtained. Usually, 20 to 2000 liters, of the ready-to-use spray liquor are applied per hectare of agricultural useful area.

The mixtures of the invention are suitable for use in protecting crops, plants, plant propagation materials, e.g. seeds, or soil or water, in which the plants are growing, from attack or infestation by animal pests. Therefore, the invention also relates to a plant protection method, which comprises contacting crops, plants, plant propagation materials, e.g. seeds, or soil or water, in which the plants are growing, to be protected from attack or infestation by animal pests, with a pesticidally effective amount of a mixture of the invention.

The mixture of the invention are also suitable for use in combating or controlling animal pests. Therefore, the invention also relates to a method of combating or controlling animal pests, which comprises contacting the animal pests, their habitat, breeding ground, or food supply, or the crops, plants, plant propagation materials, e.g. seeds, or soil, or the area, material or environment in which the animal pests are growing or may grow, with a pesticidally effective amount of a mixture of the invention.

The mixtures of the invention are effective through both contact and ingestion to any and all developmental stages, such as egg, larva, pupa, and adult.

The mixtures of the invention can be applied as such or in form of compositions comprising them.

The application can be carried out both before and after the infestation of the crops, plants, plant propagation materials by the pests.

The term “contacting” includes both direct contact (applying the compounds/compositions directly on the animal pest or plant) and indirect contact (applying the compounds/compositions to the locus).

The term “animal pest” includes arthropods, gastropods, and nematodes. Preferred animal pests according to the invention are arthropods, preferably insects and arachnids, in particular insects.

The term “plant” includes cereals, e.g. durum and other wheat, rye, barley, triticale, oats, rice, or maize (fodder maize and sugar maize/sweet and field corn); beet, e.g. sugar beet, or fodder beet; fruits, e.g. pomes, stone fruits, or soft fruits, e.g. apples, pears, plums, peaches, nectarines, almonds, cherries, papayas, strawberries, raspberries, blackberries or gooseberries; leguminous plants, e.g. beans, lentils, peas, alfalfa, or soybeans; oil plants, e.g. rapeseed (oilseed rape), turnip rape, mustard, olives, sunflowers, coconut, cocoa beans, castor oil plants, oil palms, ground nuts, or soybeans; cucurbits, e.g. squashes, pumpkins, cucumber or melons; fiber plants, e.g. cotton, flax, hemp, or jute; citrus fruit, e.g. oranges, lemons, grape-fruits or mandarins; vegetables, e.g. eggplant, spinach, lettuce (e.g. iceberg lettuce), chicory, cabbage, asparagus, cabbages, carrots, onions, garlic, leeks, tomatoes, potatoes, cucurbits or sweet peppers; lauraceous plants, e.g. avocados, cinnamon, or camphor; energy and raw material plants, e.g. corn, soybean, rapeseed, sugar cane or oil palm; tobacco; nuts, e.g. walnuts; pistachios; coffee; tea; bananas; vines; hop; sweet leaf (Stevia); natural rubber plants or ornamental and forestry plants, shrubs, broad-leaved trees or evergreens, eucalyptus; turf; lawn; grass. Preferred plants include potatoes sugar beets, tobacco, wheat, rye, barley, oats, rice, corn, cotton, soybeans, rapeseed, legumes, sunflowers, coffee, or sugar cane; fruits; vines; ornamentals; or vegetables, e.g. cucumbers, tomatoes, beans or squashes.

The term “seed” embraces seeds and plant propagules including true seeds, seed pieces, suckers, corms, bulbs, fruit, tubers, grains, cuttings, cut shoots, and means preferably true seeds.

“Pesticidally effective amount” means the amount of active ingredient needed to achieve an observable effect on growth, including the effects of necrosis, death, retardation, prevention, and removal, destruction, or otherwise diminishing the occurrence and activity of the target organism. The pesticidally effective amount can vary for the various compounds/compositions used in the invention. A pesticidally effective amount of the compositions will also vary according to the prevailing conditions e.g. desired pesticidal effect and duration, weather, target species, locus, mode of application.

For use in treating crop plants, e.g. by foliar application, the rate of application of the active ingredients of this invention may be in the range of 0.0001 g to 4000 g per hectare, e.g. from 1 g to 2 kg per hectare or from 1 g to 750 g per hectare, desirably from 1 g to 100 g per hectare.

The mixtures of the invention are also suitable for use against non-crop insect pests. For use against said non-crop pests, compounds I can be used as bait composition, gel, general insect spray, aero-sol, as ultra-low volume application and bed net (impregnated or surface applied).

The term “non-crop insect pest” refers to pests, which are particularly relevant for non-crop targets, e.g. ants, termites, wasps, flies, ticks, mosquitoes, bed bugs, crickets, or cockroaches, such as: Aedes aegypti, Musca domestica, Tribolium spp.; termites such as Reticulitermes flavipes, Coptotermes formosanus; roaches such as Blatella germanica, Periplaneta Americana; ants such as Solenopsis invicta, Linepithema humile, and Camponotus pennsylvanicus.

The bait can be a liquid, a solid or a semisolid preparation (e.g. a gel). For use in bait compositions, the typical content of active ingredient is from 0.001 wt % to 15 wt %, desirably from 0.001 wt % to 5 wt % of active compound.

The mixtures of the invention and its compositions can be used for protecting wooden materials such as trees, board fences, sleepers, frames, artistic artifacts, etc. and buildings, but also construction materials, furniture, leathers, fibers, vinyl articles, electric wires and cables etc. from ants, termites and/or wood or textile destroying beetles, and for controlling ants and termites from doing harm to crops or human beings (e.g. when the pests invade into houses and public facilities or nest in yards, orchards or parks).

Customary application rates in the protection of materials are, e.g., from 0.001 g to 2000 g or from 0.01 g to 1000 g of active compound per m² treated material, desirably from 0.1 g to 50 g per m².

Insecticidal compositions for use in the impregnation of materials typically contain from 0.001 to 95 wt %, preferably from 0.1 to 45 wt %, and more preferably from 1 to 25 wt % of at least one repellent and/or insecticide.

The mixtures of the invention are especially suitable for efficiently combating animal pests e.g. arthropods, and nematodes including:
insects from the sub-order of Auchenorrhyncha, e.g. Amrasca biguttula, Empoasca spp., Nephotettix virescens, Sogatella furcifera, Mahanarva spp., Laodelphax striatellus, Mahanarva fimbriolata, Nilaparvata lugens, Diaphorina citri;
Lepidoptera, e.g. Diatraea saccharalis, Helicoverpa spp., Heliothis virescens, Lobesia botrana, Manduca sexta, Ostrinia nubilalis, Plutella xylostella, Pseudoplusia includens, Scirpophaga incertulas, Sesamia sp., Spodoptera spp., Trichoplusia ni, Tuta absoluta, Cnaphalocrocis medialis, Cydia pomonella, Chilo suppressalis, Anticarsia gemmatalis, Agrotis ipsilon, Chrysodeixis includens;
True bugs, e.g. Lygus spp., Stink bugs such as Euschistus spp., Halyomorpha halys, Nezara viridula, Piezodorus guildinii, Dichelops furcatus;
Thrips, e.g. Frankliniella spp., Thrips spp., Dichromothrips corbettii;
Aphids, e.g. Acyrthosiphon pisum, Aphis spp., Myzus persicae, Macrosiphum euphorbiae, Rhopalosiphum spp., Schizaphis graminum, Megoura viciae;
Whiteflies, e.g. Trialeurodes vaporariorum, Bemisia spp.;
Coleoptera, e.g. Atomaria linearia, Phyllotreta spp., Melanotus spp., Meligethes aeneus, Leptinotarsa decimlineata, Ceutorhynchus spp., Diabrotica spp., Anthonomus grandis, Atomaria linearia, Agriotes spp., Epilachna spp.; Hypothenemus hampei; Lissorhoptrus oryzophilus; Melanotus spp.; Otiorhynchus sulcatus; Oulema spp.; Phyllotreta spp.; Popillia japonica; Psylliodes chrysocephala;
Flies, e.g. Delia spp., Ceratitis capitata, Bactrocera spp., Liriomyza spp.; Mayetiola destructor; Rhagoletis spp.
Coccoidea, e.g. Aonidiella aurantia, Ferrisia virgate; Coccus spp.; Quadraspidiotus preniciosus
Anthropods of class Arachnida (Mites), e.g. Penthaleus major, Panonychus spp.; Tetranychus spp.;
Nematodes, e.g. Heterodera glycines, Meloidogyne spp., Pratylenchus spp., Caenorhabditis elegans.

The mixtures of the invention are suitable for use in treating or protecting animals against infestation or infection by parasites. Therefore, the invention also relates to the use of a compound of the invention for the manufacture of a medicament for the treatment or protection of animals against infestation or infection by parasites. Furthermore, the invention relates to a method of treating or protecting animals against infestation and infection by parasites, which comprises orally, topically or parenterally administering or applying to the animals a parasiticidally effective amount of a compound I.

The invention also relates to the non-therapeutic use of compounds of the invention for treating or protecting animals against infestation and infection by parasites. Moreover, the invention relates to a non-therapeutic method of treating or protecting animals against infestation and infection by parasites, which comprises applying to a locus a parasiticidally effective amount of a mixture of the invention.

The mixtures of the invention are further suitable for use in combating or controlling parasites in and on animals. Furthermore, the invention relates to a method of combating or controlling parasites in and on animals, which comprises contacting the parasites with a parasitically effective amount of a mixture of the invention.

The invention also relates to the non-therapeutic use of the mixtures of the invention for controlling or combating parasites. Moreover, the invention relates to a non-therapeutic method of combating or controlling parasites, which comprises applying to a locus a parasiticidally effective amount of a mixture of the invention.

The mixtures of the invention can be effective through both contact (via soil, glass, wall, bed net, carpet, blankets or animal parts) and ingestion (e.g. baits). Furthermore, the compounds I can be applied to any and all developmental stages.

The mixtures of the invention can be applied as such or in form of compositions comprising them.

The term “locus” means the habitat, food supply, breeding ground, area, material or environment in which a parasite is growing or may grow outside of the animal.

As used herein, the term “parasites” includes endo- and ectoparasites. In some embodiments of the invention, endoparasites can be preferred. In other embodiments, ectoparasites can be preferred. Infestations in warm-blooded animals and fish include lice, biting lice, ticks, nasal bots, keds, biting flies, muscoid flies, flies, myiasitic fly larvae, chiggers, gnats, mosquitoes and fleas.

The mixtures of the invention are especially useful for combating the following parasites: Cimex lectularius, Rhipicephalus sanguineus, and Ctenocephalides felis.

As used herein, the term “animal” includes warm-blooded animals (including humans) and fish. Preferred are mammals, such as cattle, sheep, swine, camels, deer, horses, pigs, poultry, rabbits, goats, dogs and cats, water buffalo, donkeys, fallow deer and reindeer, and also in furbearing animals such as mink, chinchilla and raccoon, birds such as hens, geese, turkeys and ducks and fish such as fresh- and salt-water fish such as trout, carp and eels. Particularly preferred are domestic animals, such as dogs or cats.

The mixtures of the invention may be applied in total amounts of 0.5 mg/kg to 100 mg/kg per day, preferably 1 mg/kg to 50 mg/kg per day.

For oral administration to warm-blooded animals, the compounds I may be formulated as animal feeds, animal feed premixes, animal feed concentrates, pills, solutions, pastes, suspensions, drenches, gels, tablets, boluses and capsules. For oral administration, the dosage form chosen should provide the animal with 0.01 mg/kg to 100 mg/kg of animal body weight per day of the mixtures of the invention, preferably with 0.5 mg/kg to 100 mg/kg of animal body weight per day.

Alternatively, the mixtures of the invention may be administered to animals parenterally, e.g., by intraruminal, intramuscular, intravenous or subcutaneous injection. The compounds I may be dispersed or dissolved in a physiologically acceptable carrier for subcutaneous injection. Alternatively, the mixtures of the invention may be formulated into an implant for subcutaneous administration. In addition, the mixtures of the invention may be transdermally administered to animals. For parenteral administration, the dosage form chosen should provide the animal with 0.01 mg/kg to 100 mg/kg of animal body weight per day of the mixtures of the invention.

The mixtures of the invention may also be applied topically to the animals in the form of dips, dusts, powders, collars, medallions, sprays, shampoos, spot-on and pour-on formulations and in ointments or oil-in-water or water-in-oil emulsions. For topical application, dips and sprays usually contain 0.5 ppm to 5,000 ppm and preferably 1 ppm to 3,000 ppm of the compounds I. In addition, the mixtures of the invention may be formulated as ear tags for animals, particularly quadrupeds e.g. cattle and sheep.

Oral solutions are administered directly.

Solutions for use on the skin are trickled on, spread on, rubbed in, sprinkled on or sprayed on.

Gels are applied to or spread on the skin or introduced into body cavities.

Pour-on formulations are poured or sprayed onto limited areas of the skin, the active compound penetrating the skin and acting systemically. Pour-on formulations are prepared by dissolving, suspending or emulsifying the active compound in suitable skin-compatible solvents or solvent mixtures.

Emulsions can be administered orally, dermally or as injections.

Suspensions can be administered orally or topically/dermally.

Semi-solid preparations can be administered orally or topically/dermally.

For the production of solid preparations, the active compound is mixed with suitable excipients, if appropriate with addition of auxiliaries, and brought into the desired form.

The compositions which can be used in the invention can comprise generally from about 0.001 to 95% of the mixture.

Ready-to-use preparations contain the compounds acting against parasites, preferably ectoparasites, in concentrations of 10 ppm to 80% by weight, preferably from 0.1 to 65% by weight, more preferably from 1 to 50% by weight, most preferably from 5 to 40% by weight.

Preparations which are diluted before use contain the compounds acting against ectoparasites in concentrations of 0.5 to 90% by weight, preferably of 1 to 50% by weight.

Furthermore, the preparations comprise the compounds of formula I against endoparasites in concentrations of 10 ppm to 2% by weight, preferably of 0.05 to 0.9% by weight, very particularly preferably of 0.005 to 0.25% by weight.

Solid formulations which release compounds of the invention may be applied in total amounts of 10 mg/kg to 300 mg/kg, preferably 20 mg/kg to 200 mg/kg, most preferably 25 mg/kg to 160 mg/kg body weight of the treated animal in the course of three weeks.

### BIOLOGICAL EXAMPLES OF THE INVENTION

The invention is now illustrated in further details by the following examples.

Synergism can be described as an interaction where the combined effect of two or more compounds is greater than the sum of the individual effects of each of the compounds. The presence of a synergistic effect in terms of percent control, between two mixing partners (X and Y) can be calculated using the Colby equation (Colby, S. R., 1967, Calculating Synergistic and Antagonistic Responses in Herbicide Combinations, Weeds, 15, 20-22):

$$E = X + Y - \frac{X Y}{100}$$

When the observed combined control effect is greater than the expected combined control effect (E), then the combined effect is synergistic.

The following tests demonstrate the control efficacy of compounds, mixtures or compositions of this invention on specific pests. However, the pest control protection afforded by the compounds, mixtures or compositions is not limited to these species. In certain instances, combinations of a compound of this invention with other invertebrate pest control compounds or agents are found to exhibit synergistic effects against certain important invertebrate pests.

The analysis of synergism or antagonism between the mixtures or compositions was determined using Colby's equation.

### Test 1

For evaluating control of tobacco budworm (Heliothis virescens) the test unit consisted of 96-well-microtiter plates containing an insect diet and 15-25 H. virescens eggs.

The compounds or mixtures were formulated using a solution containing 75% water and 25% DMSO. Different concentrations of formulated compounds or mixtures were sprayed onto the insect diet at 10 μl, using a custom-built micro atomizer, at two replications.

For experimental mixtures in these tests, identical volumes of both mixing partners at the desired concentrations respectively, were mixed together.

After application, microtiter plates were incubated at 28±1° C., 80±5% RH for 5 days. Egg and larval mortality were then visually assessed. For the mixture tested the results are listed in Tables 1.1 to 1.7, wherein the * marks synergistic control effect according to Colby's equation.

TABLE 1.1

| | Concen- | | Average | Average |
|---|---|---|---|---|
| | tration | | control | control |
| Compound | (ppm) | Mixture | observed (%) | expected (%) |
| I-1 | 0.009 | | 0 | |
| I-1 | 0.048 | | 0 | |
| I-1 | 0.24 | | 0 | |
| alpha- | 0.4 | | 25 | |
| cypermethrin (2a) | | | | |
| Bifenthrin (2b) | 0.4 | | 0 | |
| Thiamethoxam | 0.03 | | 0 | |
| (3a) | | | | |
| Spinetoram (4b) | 0.2 | | 0 | |
| I-1 + alpha- | 0.048 + 0.4 | 1:8 | 50* | 0 |
| cypermethrin (2a) | | | | |
| I-1 + Bifenthrin | 0.048 + 0.4 | 1:8 | 50* | 0 |
| (2b) | | | | |
| I-1 + | 0.24 + 0.03 | 8:1 | 100* | 0 |
| Thiamethoxam | | | | |
| (3a) | | | | |
| I-1 + | 0.009 + 0.2 | 1:22 | 75* | 0 |
| Spinetoram (4b) | | | | |

TABLE 1.2

| | Concen- | | Average | Average |
|---|---|---|---|---|
| | tration | | control | control |
| Compound | (ppm) | Mixture | observed (%) | expected (%) |
| I-1 | 0.24 | | 0 | |
| Fipronil (1b) | 0.08 | | 0 | |
| I-1 + | 0.24 + 0.8 | 1:3 | 100* | 0 |
| Fipronil (1b) | | | | |

TABLE 1.3

| | Concen- | | Average | Average |
|---|---|---|---|---|
| | tration | | control | control |
| Compound | (ppm) | Mixture | observed (%) | expected (%) |
| I-1 | 0.009 | | 0 | |
| lamda-cyhalothrin | 0.16 | | 50 | |
| (2e) | | | | |
| I-1 + | 0.009 + 0.16 | 1:2 | 100* | 50 |
| lamda-cyhalothrin | | | | |
| (2e) | | | | |

TABLE 1.4

| | Concen- | | Average | Average |
|---|---|---|---|---|
| | tration | | control | control |
| Compound | (ppm) | Mixture | observed (%) | expected (%) |
| I-1 | 0.048 | | 0 | |
| Dinotefuran (3f) | 20 | | 0 | |
| I-1 + | 0.048 + 20 | 1:417 | 50 | |
| Dinotefuran (3f) | | | | |

TABLE 1.5

| | Concen- | | Average | Average |
|---|---|---|---|---|
| | tration | | control | control |
| Compound | (ppm) | Mixture | observed (%) | expected (%) |
| I-1 | 0.048 | | 0 | |
| Methoxyfenozide | 0.4 | | 37.5 | |
| (11) | | | | |
| I-1 + | 0.048 + 0.4 | 1:8 | 62.5* | 37.5 |
| Methoxyfenozide | | | | |
| (11) | | | | |

TABLE 1.6

| | Concen- | | Average | Average |
|---|---|---|---|---|
| | tration | | control | control |
| Compound | (ppm) | Mixture | observed (%) | expected (%) |
| I-1 | 0.048 | | 0 | |
| Indoxacarb (12) | 0.4 | | 0 | |
| I-1 + | 0.048 + 0.4 | 1:8 | 50* | 0 |
| Indoxacarb (12) | | | | |

TABLE 1.7

| | Concen- | | Average | Average |
|---|---|---|---|---|
| | tration | | control | control |
| Compound | (ppm) | Mixture | observed (%) | expected (%) |
| I-1 | 0.009 | | 0 | |
| Flubendiamide (14a) | 0.4 | | 12.5 | |
| I-1 + | 0.009 + 0.4 | 1:44 | 62.5* | 37.5 |
| Flubendiamide (14a) | | | | |

### Test 2

For evaluating control of yellow fever mosquito (Aedes aegypti) the test unit consisted of 96-well-microtiter plates containing 200 μl of tap water per well and 5-15 freshly hatched A. aegypti larvae.

The compounds or mixtures were formulated using a solution containing 75% water and 25% DMSO. Different concentrations of formulated compounds or mixtures were sprayed onto the insect diet at 2.5 μl, using a custom-built micro atomizer, at two replications.

For experimental mixtures in these tests identical volumes of both mixing partners at the desired concentrations respectively, were mixed together.

After application, microtiter plates were incubated at 28±1° C., 80±5% RH for 2 days. Larval mortality was then visually assessed. For the mixture tested the results are listed in Table 2.1 to 2.11, wherein the * marks synergistic control effect according to Colby's equation.

TABLE 2.1

| | Concen- | | Average | Average |
|---|---|---|---|---|
| | tration | | control | control |
| Compound | (ppm) | Mixture | observed (%) | expected (%) |
| I-1 | 0.24 | | 0 | |
| I-1 | 1.2 | | 50 | |
| Bifenthrin (2b) | 0.4 | | 25 | |
| Clothianidin (3c) | 1 | | 0 | |
| I-1 + | 0.24 + 0.4 | 1:1.7 | 50* | <25 |
| Bifenthrin (2b) | | | | |
| I-1 + | 1.2 + 1 | 1.2:1 | 75* | <50 |
| Clothianidin (3c) | | | | |

TABLE 2.2

| | Concen- | | Average | Average |
|---|---|---|---|---|
| | tration | | control | control |
| Compound | (ppm) | Mixture | observed (%) | expected (%) |
| I-1 | 0.009 | | 0 | |
| Fipronil (1b) | 0.4 | | 0 | |
| I-1 + | 0.009 + 0.4 | 1:44 | 75* | 0 |
| Fipronil | | | | |

TABLE 2.3

| | Concen- | | Average | Average |
|---|---|---|---|---|
| | tration | | control | control |
| Compound | (ppm) | Mixture | observed (%) | expected (%) |
| I-1 | 0.048 | | 0 | |
| Cyfluthrin (2c) | 0.4 | | 0 | |
| I-1 + | 0.048 + 0.4 | 1:80 | 75* | 0 |
| Cyfluthrin | | | | |

TABLE 2.4

| | Concen- | | Average | Average |
|---|---|---|---|---|
| | tration | | control | control |
| Compound | (ppm) | Mixture | observed (%) | expected (%) |
| I-1 | 0.009 | | 0 | |
| lambda Cyhalothrin | 0.16 | | 0 | |
| (2e) | | | | |
| I-1 + | 0.009 + 0.16 | 1:18 | 75* | 0 |
| lambda Cyhalothrin | | | | |

TABLE 2.5

| | | | Average | Average |
|---|---|---|---|---|
| | Concentration | | control | control |
| Compound | (ppm) | Mixture | observed (%) | expected (%) |
| I-1 | 0.048 | | 0 | |
| Acetamiprid (3d) | 4 | | 0 | |
| I-1 + | 0.048 + 4 | 1:8.3 | 100* | 0 |
| Acetamiprid | | | | |

TABLE 2.6

| | | | Average | Average |
|---|---|---|---|---|
| | Concentration | | control | control |
| Compound | (ppm) | Mixture | observed (%) | expected (%) |
| I-1 | 0.048 | | 0 | |
| Thiacloprid (3e) | 4 | | 50 | |
| I-1 + | 0.048 + 4 | 1:8.3 | 75* | 50 |
| Thiacloprid | | | | |

TABLE 2.7

| | | | Average | Average |
|---|---|---|---|---|
| | Concentration | | control | control |
| Compound | (ppm) | Mixture | observed (%) | expected (%) |
| I-1 | 0.24 | | 0 | |
| Dinotefuran (3f) | 4 | | 0 | |
| I-1 + | 0.24 + 4 | 1:17 | 75* | 0 |
| Dinotefuran | | | | |

TABLE 2.8

| | | | Average | Average |
|---|---|---|---|---|
| | Concentration | | control | control |
| Compound | (ppm) | Mixture | observed (%) | expected (%) |
| I-1 | 0.24 | | 0 | |
| Chlorfenapyr (8) | 0.8 | | 0 | |
| I-1 + | 0.24 + 0.8 | 1:3 | 87.5* | 0 |
| Chlorfenapyr | | | | |

TABLE 2.9

| | | | Average | Average |
|---|---|---|---|---|
| | Concentration | | control | control |
| Compound | (ppm) | Mixture | observed (%) | expected (%) |
| I-1 | 0.24 | | 0 | |
| I-1 | 1.2 | | 0 | |
| Indoxacarb (12) | 0.08 | | 0 | |
| Indoxacarb (12) | 0.4 | | 0 | |
| Indoxacarb (12) | 2 | | 0 | |
| I-1 + | 1.2 + 0.08 | 15:1 | 100* | 0 |
| Indoxacarb | | | | |
| I-1 + | 1.2 + 0.4 | 3:1 | 100* | 0 |
| Indoxacarb | | | | |
| I-1 + | 0.24 + 2 | 1:8.3 | 50* | 0 |
| Indoxacarb | | | | |

TABLE 2.10

| | Concen- | | Average | Average |
|---|---|---|---|---|
| | tration | | control | control |
| Compound | (ppm) | Mixture | observed (%) | expected (%) |
| I-1 | 0.24 | | 0 | |
| Spirotetramat (13a) | 80 | | 0 | |
| I-1 + | 0.24 + 80 | 1:333 | 50* | 0 |
| Spirotetramat | | | | |

TABLE 2.11

| | | | Average | Average |
|---|---|---|---|---|
| | Concentration | | control | control |
| Compound | (ppm) | Mixture | observed (%) | expected (%) |
| I-1 | 0.009 | | 0 | |
| Broflanilide (16) | 2 | | 12.5 | |
| I-1 + | 0.009 + 2 | 1:222 | 50* | 12.5 |
| Broflanilide | | | | |

### Test 3

For evaluating control of green peach aphid (Myzus persicae) through systemic means the test unit consisted of 96-well-microtiter plates containing liquid artificial diet under an artificial membrane.

The compounds or mixtures were formulated using a solution containing 75% water and 25% DMSO. Different concentrations of formulated compounds or mixtures were pipetted into the aphid diet, using a custom built pipetter, at two replications.

For experimental mixtures in these tests identical volumes of both mixing partners at the desired concentrations respectively, were mixed together.

After application, 5-8 adult aphids were placed on the artificial membrane inside the microtiter plate wells. The aphids were then allowed to suck on the treated aphid diet and incubated at 23±1° C. 50±5% RH for 3 days. Aphid mortality and fecundity was then visually assessed. For the mixture tested the results are listed in tables 3.1 to 3.3, wherein the * marks synergistic control effect according to Colby's equation.

TABLE 3.1

| | | | Average | Average |
|---|---|---|---|---|
| | Concen- | | control | control |
| | tration | | observed | expected |
| Compound | (ppm) | Mixture | (%) | (%) |
| I-1 | 0.24 | | 0 | |
| I-1 | 1.2 | | 25 | |
| Chlorantraniliprole | 0.4 | | 0 | |
| (14b) | | | | |
| Dimpropyridaz | 2 | | 0 | |
| (17b) | | | | |
| I-1 + | 0.24 + 0.4 | 1:1.7 | 75* | 0 |
| Chlorantraniliprole | | | | |
| (14b) | | | | |
| I-1 + Dimpropyridaz | 1.2 + 2 | 1.2:1 | 75* | <25 |
| (17b) | | | | |

TABLE 3.2

| | | | Average | Average |
|---|---|---|---|---|
| | Concentration | | control | control |
| Compound | (ppm) | Mixture | observed (%) | expected (%) |
| I-1 | 0.009 | | 0 | |
| Imidacloprid (3b) | 0.8 | | 0 | |
| I-1 + | 0.009 + 0.8 | 1:9 | 100* | 0 |
| Imidacloprid | | | | |

TABLE 3.3

| | Concen- | | Average | Average |
|---|---|---|---|---|
| | tration | | control | control |
| Compound | (ppm) | Mixture | observed (%) | expected (%) |
| I-1 | 1.2 | | 0 | |
| Flupyradifurone (3i) | 2 | | 12.5 | |
| I-1 + | 1.2 + 2 | 1:1.7 | 100* | 12.5 |
| Flupyradifurone | | | | |

### Test 4

For evaluating control of boll weevil (Anthonomus grandis) the test unit consisted of 24-well-microtiter plates containing an insect diet and 20-30 A. grandis eggs.

The compounds or mixtures were formulated using a solution containing 75% water and 25% DMSO. Different concentrations of formulated compounds or mixtures were sprayed onto the insect diet at 20 μl, using a custom-built micro atomizer, at two replications.

For experimental mixtures in these tests identical volumes of both mixing partners at the desired concentrations respectively, were mixed together.

After application, microtiter plates were incubated at 23±1° C., 50±5% RH for 5 days. Egg and larval mortality was then visually assessed. For the mixture tested the results are listed in tables 4.1 to 4.4, wherein the * marks synergistic control effect according to Colby's equation.

TABLE 4.1

| | Concen- | | Average | Average |
|---|---|---|---|---|
| | tration | | control | control |
| Compound | (ppm) | Mixture | observed (%) | expected (%) |
| I-1 | 0.24 | | 0 | |
| Thiamethoxam (3a) | 0.03 | | 0 | |
| I-1 + | 0.24 + 0.03 | 8:1 | 100* | 0 |
| Thiamethoxam | | | | |

TABLE 4.2

| | | | Average | Average |
|---|---|---|---|---|
| | Concentration | | control | control |
| Compound | (ppm) | Mixture | observed (%) | expected (%) |
| I-1 | 0.048 | | 0 | |
| Fipronil (1b) | 0.4 | | 12.5 | |
| I-1 + Fipronil | 0.048 + 0.4 | 1:8.3 | 62.5* | 12.5 |

TABLE 4.3

| | Concen- | | Average | Average |
|---|---|---|---|---|
| | tration | | control | control |
| Compound | (ppm) | Mixture | observed (%) | expected (%) |
| I-1 | 0.048 | | 0 | |
| Teflubenzuron (9) | 0.1 | | 12.5 | |
| I-1 + Teflubenzuron | 0.048 + 0.1 | 1:2.1 | 100* | 12.5 |

TABLE 4.4

| | | | Average | Average |
|---|---|---|---|---|
| | Concentration | | control | control |
| Compound | (ppm) | Mixture | observed (%) | expected (%) |
| I-1 | 0.24 | | 0 | |
| Indoxacarb (12) | 0.08 | | 25 | |
| I-1 + Indoxacarb | 0.24 + 0.08 | 3:1 | 100* | 12.5 |

### Test 5

For evaluating control of tobacco budworm (Plutella xylostella) the test unit consisted of 96-well-microtiter plates containing an insect diet and 15-25 P. xylostella eggs.

The compounds or mixtures were formulated using a solution containing 75% water and 25% DMSO. Different concentrations of formulated compounds or mixtures were sprayed onto the insect diet at 5 μl, using a custom-built micro atomizer, at two replications.

For experimental mixtures in these tests identical volumes of both mixing partners at the desired concentrations respectively, were mixed together.

After application, microtiter plates were incubated at 28±1° C., 80±5% RH for 5 days. Egg and larval mortality was then visually assessed. For the mixture tested the results are listed in table 5.

TABLE 5

| | Concen- | | Average | Average |
|---|---|---|---|---|
| | tration | | control | control |
| Compound | (ppm) | Mixture | observed (%) | expected (%) |
| I-1 | 0.05 | | 0 | |
| Thiamethoxam (3a) | 0.03 | | 0 | |
| I-1 + | 0.05 + 0.03 | 1.7:1 | 100* | 0 |
| Thiamethoxam (3a) | | | | |

*synergistic control effect according to Colby's equation

1. A pesticidal mixture comprising as active components
1) at least one isochinoline compound A of formula I: 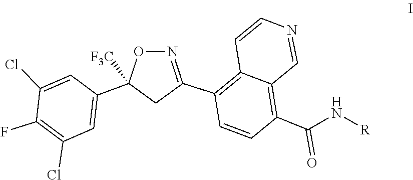
wherein
R is CH₂-pyrimidine-2 or cyclpropyl;
and
B) at least one further compound B selected from the group consisting of
1) M.2 GABA-gated chloride channel antagonists: ethiprole and fipronil;
2) M.3 pyrethroids: alpha-cypermethrin, bifenthrin, cyfluthrin, etofenprox, lamda-cyhalothrin, gamma-cyhalothrin, and deltamethrin;
3) nAChR agonists: thiamethoxam, imidacloprid, clothianidin, acetamiprid, thiacloprid, dinotefuran, nitenpyram, sulfoxaflor, flupyradifurone, and triflumezopyrim;
4) spinosyns: spinosad and spinetoram;
5) M.6 avermectins: abamectin, and emamectin benzoate;
6) M.7 juvenile hormone analogue pyriproxyfen;
7) M.9 pymetrozine and afidopyropen;
8) M.13 Uncoupler of oxidative phosphorylation via disruption of the proton gradient: chlorfenapyr;
9) M.15 Inhibitor of the chitin biosynthesis type 0: teflubenzuron;
10) M.16 Inhibitor of the chitin biosynthesis type 1: buprofezin;
11) M.18 Ecdyson receptor agonist: methoxyfenozide;
12) M.22 Voltage-dependent sodium channel blocker: indoxacarb;
13) M.23 Inhibitors of the of acetyl CoA carboxylase: spirotetramat, spiropidion, and spidoxamat;
14) M.28 Ryanodine receptor-modulators: chlorantraniliprole, cyantraniliprole, cyhalodiamide, cyclaniliprole, flubendiamide, tetrachlorantraniliprole, and tetraniliprole;
15) M.29: Chordotonal organ Modulator: flonicamid;
16) M.30: broflanilide; and
17) M.UN. Unknown mode of action: dicloromezotiaz, dimpropyridaz, flupyrimin, and oxazosulfyl;
wherein component A and component B are present in a weight ratio of from 1000:1 to 1:1000.

2. The mixture of claim 1, wherein compound A is compound I-1:
(I-1): 5-[(5S)-5-(3,5-dichloro-4-fluoro-phenyl)-5-(trifluoromethyl)-4H-isoxazol-3-yl]-N-(pyrimidin-2-ylmethyl)isoquinoline-8-carboxamide.

3. The mixture of claim 1 comprising one compound A and one compound B.

4. The mixture of claim 1 wherein component 2) is selected from the group consisting of alpha-cypermethrin, bifenthrin, cyfluthrin, etofenprox, lamda-cyhalothrin, gamma-cyhalothrin, and deltamethrin.

5. The mixture of claim 1 wherein component 2) is selected from the group consisting of alpha-cypermethrin, bifenthrin, cyfluthrin, and lamda-cyhalothrin.

6. The mixture of claim 1 wherein component 2) is selected from the group consisting of thiamethoxam, imidacloprid, clothianidin, acetamiprid, thiacloprid, dinotefuran, sulfoxaflor, flupyradifurone, and triflumezopyrim.

7. The mixture of claim 1 wherein component 2) is selected from the group consisting of thiamethoxam, imidacloprid, clothianidin, acetamiprid, thiacloprid, and triflumezopyrim.

8. The mixture of claim 1 wherein component 2) is selected from spinosad and spinetoram.

9. The mixture of claim 1 wherein component 2) is spinetoram.

10. The mixture of claim 1 wherein component 2) is selected from the group consisting of flubendiamide, chlorantraniliprole, cyantraniliprole, and tetraniliprole.

11. The mixture of claim 1 wherein component 2) is selected from chlorantraniliprole and cyantraniliprole.

12. The mixture of claim 1 wherein component 2) is selected from the group consisting of fipronil, spinetoram, chlorfenapyr, teflubenzuron, methoxyfenozide, indoxacarb, spirotetramat, broflanilide, and dimpropyridaz.

13. The mixture of claim 1, comprising the compound A and the active compound B in a weight ratio of from 25:1 to 1:25.

14. A composition comprising a pesticidal mixture according to claim 1 and at least one inert liquid and/or solid carrier.

15. An agricultural composition for combating animal pests comprising a pesticidal mixture according to claim 1 and at least one inert liquid and/or solid acceptable carrier and, optionally, at least one surfactant.

16. A method for combating or controlling an invertebrate, pest comprising contacting said invertebrate pest or its food supply, habitat or breeding grounds with a pesticidally effective amount of a pesticidal mixture according to claim 1.

17. A method for protecting growing plants or plant propagation materials from attack or infestation by an invertebrate pest comprising contacting a plant, a plant propagation material or soil or water in which the plant is growing, with a pesticidally effective amount of a pesticidal mixture according to claim 1.

18. (canceled)

19. A method for combating parasites in and on an animal comprising contacting the animal with an effective amount of a pesticidal mixture according to claim 1.
